(19) United States
(12) Patent Application Publication
(10) Pub. No.: US 2007/0109221 A1
(43) Pub. Date: May 17, 2007

(54) Method of driving discharge display panel for effective initialization

(76) Inventor: Seong-Joong Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/478,498

(22) Filed: Jun. 28, 2006

(30) Foreign Application Priority Data
Nov. 11, 2005 (KR) 10-2005-0108069

(51) Int. Cl. G09G 3/28

(52) U.S. Cl. 345/63

(57) ABSTRACT

A method of driving a discharge display panel is disclosed The method includes dividing a unit frame with a plurality of subfields for a time-division gradation display, and dividing each of the subfields into an initialization period, an addressing period, and a sustaining period, wherein a driving power for the initialization in a subfield having a large gradation weight is lower than that in each of the other subfields.

### CROSS-REFERENCE TO RELATED APPLICATIONS

This application claims the benefit of Korean Patent Application No. 10-2005-0108069, filed on Nov. 11, 2005, in the Korean Intellectual Property Office, the disclosure of which is incorporated herein in its entirety by reference.

### BACKGROUND

1. Field of the Invention

The present invention relates to a method of driving a discharge display panel, and more particularly, to a method of driving a discharge display panel which divides a unit frame for time-division gradation display into a plurality of subfields, each subfield including an initializing period, an addressing period, and a sustaining period.

2. Description of Related Technology

A conventional plasma display apparatus, which is a discharge display apparatus, divides a unit frame into a plurality of subfields for a time-division gradation display, wherein each of the subfields includes an initializing period, an addressing period, and a sustaining period.

Each subfield has a unique gradation weight, and the sustaining period is set in proportion to this gradation weight. For example, when 8 subfields included in a unit frame are represented by 256 gradations, a sustaining period of a first subfield is set to a time 1T corresponding to 2⁰, a sustaining period of a second subfield is set to a time 2T corresponding to 2¹, a sustaining period of a third subfield is set to a time 4T corresponding to 2², a sustaining period of a fourth subfield is set to a time 8T corresponding to 2³, a sustaining period of a fifth subfield is set to a time 16T corresponding to 2⁴, a sustaining period of a sixth subfield is set to a time 32T corresponding to 2⁵, a sustaining period of a seventh subfield is set to a time 64T corresponding to 2⁶, and a sustaining period of an eighth subfield is set to a time 128T corresponding to 2⁷, respectively.

Operation during a subfield having a large gradation weight, such as the eighth subfield, most greatly affects image reproducibility. However, an initialization operation in the prior art is not properly performed in the subfield having the large gradation weight, for example, the eighth subfield, because the subfield immediately before the subfield having the large gradation weight, for example, the seventh field, has a long sustaining period and thus an excessive amount of wall charges are formed around electrode lines at a start point of the subfield having the large gradation weight.

When the initialization operation is not properly performed in the subfield having the large gradation weight, the operation in the following addressing period cannot be accurately performed, thereby adversely affecting the image reproducibility.

### SUMMARY OF CERTAIN INVENTIVE ASPECTS

One aspect of the present invention is a method of driving a discharge display panel wherein reproducibility of a displayed image can be enhanced by an effective initialization operation.

One embodiment is a method of driving a discharge display panel The method includes dividing a unit frame into a plurality of subfields for time-division gradation display, and dividing each of the subfields into an initialization period, an addressing period, and a sustaining period, where a driving power for initialization in a subfield having a higher gradation weight is lower than a driving power for initialization in a subfield having a lower gradation weight.

Another embodiment is a time-division gradation method of driving a discharge display panel. The method includes driving the display panel during a unit frame period, the unit frame period including a plurality of subfields, each subfield including an initialization period, an addressing period, and a sustaining period, and each of the plurality of subfields having a respective gradation weight. The method also includes driving the display panel during a first one of the subfields with a signal having a first driving power during an initialization period of the first subfield, the first subfield having a first gradation weight, and driving the display panel during a second subfield with a signal having a second driving power during an initialization period of the second subfield, the second subfield having a second gradation weight, where the first driving power is higher than the second driving power, and the first gradation weight is lower than the second gradation weight.

### BRIEF DESCRIPTION OF THE DRAWINGS

The above and other features and advantages will become more apparent by describing in detail embodiments thereof with reference to the attached drawings in which:

FIG. 1 is a perspective view illustrating the structure of a plasma display panel with a three-electrode surface discharge structure according to an embodiment;

FIG. 2 is a cross-sectional view of one display cell in the plasma display panel of FIG. 1;

FIG. 3 is a block diagram of a driving apparatus configured to drive the plasma display panel of FIG. 1;

FIG. 4 is a timing diagram illustrating a method of driving the plasma display panel of FIG. 1 according to an embodiment;

FIG. 5 is a timing diagram illustrating driving signals selectively transmitted to electrode lines of the discharge display panel of FIG. 1 in each subfield illustrated in FIG. 4;

FIG. 6 is a cross-sectional view illustrating the distribution of wall charges of a display cell at a t₃ timing of FIG. 5;

FIG. 7 is a cross-sectional view illustrating the distribution of wall charges of a display cell at a t₄ timing of FIG. 5;

FIG. 8 is a cross-sectional view illustrating the distribution of wall charges of a display cell at a t₈ timing of FIG. 5;

FIG. 9 is a cross-sectional view illustrating the distribution of wall charges of a display cell at t₁₀ timing of FIG. 5;

FIG. 10 is a timing diagram illustrating first and second initialization types of FIG. 5 applied in each subfield of a unit frame according to an embodiment; and

FIG. 11 is a waveform diagram illustrating a case where an initializing period of an eighth subfield having a large weight uses the second initialization type according to an embodiment.

### DETAILED DESCRIPTION OF CERTAIN INVENTIVE EMBODIMENTS

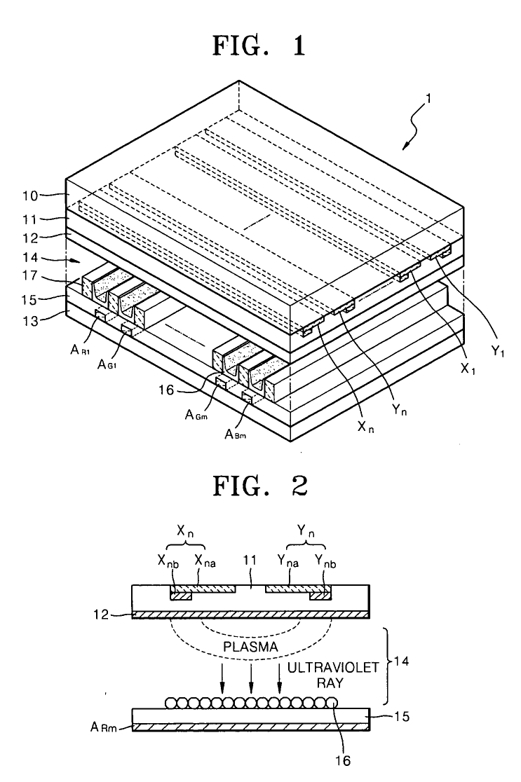

FIG. 1 is a perspective view illustrating the structure of a plasma display panel 1 with a three-electrode surface discharge structure according to an embodiment. FIG. 2 is a cross-sectional view of one display cell in the plasma display panel 1 of FIG. 1.

Referring to FIGS. 1 and 2, address electrode lines A_{R1}, . . . , A_{Bm}, dielectric layers 11 and 15, X-electrode lines X₁, . . . , Xₙ as first display electrode lines, Y-electrode lines Y₁, . . . , Yₙ as second display electrode lines, phosphors 16, barrier ribs 17, and a protective layer 12 comprising MgO in this embodiment, are provided between front and rear glass substrates 10 and 13 of a conventional surface discharge type plasma display panel 1.

The address electrode lines A_{R1}, . . . , A_{Bm} are formed in a pattern on an upper surface of the rear glass substrate 13. The lower dielectric layer 15 is formed to cover the address electrode lines A_{R1}, . . . , A_{Bm}. The barrier ribs 17 are formed in a parallel direction with the address electrode lines A_{R1}, . . . , A_{Bm} on the upper surface of the lower dielectric layer 15. The barrier ribs 17 partition discharge areas of display cells and substantially prevent cross-talk between the display cells. The phosphors 16 are formed respectively between the barrier ribs 17.

The X-electrode lines X₁, . . . , Xₙ as the first display electrode lines and Y electrode lines Y₁, . . . , Yₙ as the second display electrode lines are formed alternately and in parallel to one another on the lower surface of the front glass substrate 10 in a manner such that the X-electrode lines X₁, . . . , Xₙ and Y-electrode lines Y₁, . . . , Yₙ cross the address electrode lines A_{R1}, . . . , A_{Bm}. Each intersection occurs at a corresponding display cell. Each of the X-electrode lines X₁, . . . , Xₙ and each of the Y-electrode lines Y₁, . . . , Yₙ are formed respectively by both transparent electrode lines (Xₙₐ and Yₙₐ shown in FIG. 2) formed of a transparent conductive material such as ITO (Indium Tin Oxide) with metal electrode lines (X_{nb} and Y_{nb} shown in FIG. 2) for enhancing conductivity. The upper dielectric layer 11 is formed to cover the X-electrode lines X₁, . . . , Xₙ and Y electrode lines Y₁, . . . , Yₙ. A protective layer 12 for protecting the panel 1 in a strong electric field, for example, an MgO layer is formed on the lower surface of the front electronic layer 11. A discharge space 14 is filled with plasma-forming gas and is sealed.

According to a method of driving the plasma display panel 1, a unit subfield includes an initializing period, an addressing period, and a sustaining period sequentially executed. During the initializing period, the states of charges in all display cells are initialized. During the addressing period, wall voltages are generated in selected display cells. During the sustaining period, an alternating voltage is applied to all XY electrode line pairs. A sustaining discharge occurs in the display cells having the wall voltages generated during the addressing period. During the sustaining period, a plasma is formed in a discharge space 14, and a phosphor layer 16 is excited by ultraviolet rays emitted by the plasma and generates light.

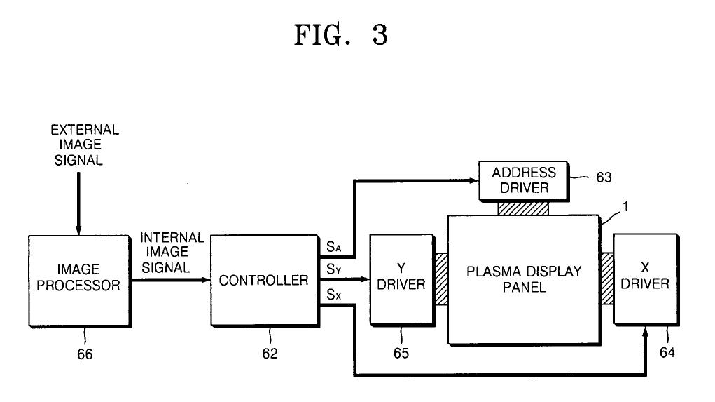

FIG. 3 is a block diagram of a driving apparatus configured to drive the plasma display panel 1 of FIG. 1. Referring to FIG. 3, the driving apparatus includes an image processor 66, a controller 62, an address driver 63, an X driver 64, and a Y driver 65.

The image processor 66 converts external analog image signals into digital signals to generate internal image signals, for example, red (R), green (G), and blue (B) image data each having 8 bits, clock signals, and vertical and horizontal synchronization signals. The controller 62 generates driving control signals S_{A}, S_{Y}, and S_{X} according to the internal image signals output from the image processor 66. The address driver 63 processes the address signal S_{A}, generates a display data signal, and transmits the display data signal to the address electrode lines A_{R1}, . . . , A_{Bm} of the plasma display panel 1. The X driver 64 processes a X driving control signal S_{X}, and transmits corresponding X driving control signals to the X electrode lines (X₁, . . . , Xₙ of FIG. 1). The Y driver 65 processes a Y driving control signal S_{Y} and transmits corresponding Y driving control signals to the Y electrode lines (Y₁, . . . , Yₙ of FIG. 1).

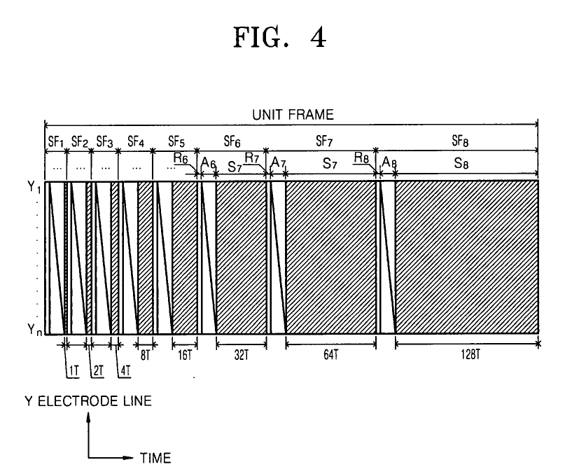

FIG. 4 is a timing diagram illustrating a method of driving the plasma display panel 1 of FIG. 1 according to an embodiment. Referring to FIG. 4, each unit frame is partitioned into 8 subfields SF₁, . . . , SF₈ in order to implement time-division gradation display. Also, the subfields SF₁, . . . , SF₈ are divided respectively into initializing periods R₁, . . . , R₈, addressing periods A₁, . . . , A₈, and sustaining periods S₁, . . . , S₈.

Discharge conditions of all the display cells are initialized during the respective initializing periods R₁, . . . , R₈ for the following addressing period.

During each of the addressing periods A₁, . . . , A₈, the display data signal is applied sequentially to the address electrode lines (A_{R1}, . . . , A_{Bm} of FIG. 1) while injection pulses corresponding to each of the Y electrode lines Y₁, . . . , Yₙ are applied sequentially to the address electrode lines. Accordingly, if a display data signal with a high level is applied while the injection pulses are applied, wall charges are generated by address discharge in a corresponding discharge cell and no wall charge is generated in the other discharge cells.

During each of the sustaining periods S₁, . . . , S₈, discharge-sustain pulses are applied alternately to all the Y electrode lines Y₁, . . . , Yₙ and all the X electrode lines X₁, . . . , Xₙ, so that the discharge cells in which the wall charges are formed cause display discharge. Accordingly, luminance of the plasma display panel is proportional to a length of a sustaining period S₁, . . . , S₈ during a unit frame. The maximum length of the sustaining period S₁, . . . , S₈ during a unit frame is 255T (T is an unit of time). Accordingly, the length of the sustaining period S₁, . . . , S₈ can be represented by 256 gradations including one gradation corresponding to no display discharge during the unit frame.

A sustaining period S₁ of a first subfield SF₁ is set to a time 1T corresponding to 2⁰, a sustaining period S₂ of a second subfield SF₂ is set to a time 2T corresponding to 2¹, a sustaining period S₃ of a third subfield SF₃ is set to a time 4T corresponding to 2², a sustaining period S₄ of a fourth subfield SF₄ is set to a time 8T corresponding to 2³, a sustaining period S₅ of a fifth subfield SF₅ is set to a time 16T corresponding to 2⁴, a sustaining period S₆ of a sixth subfield SF₆ is set to a time 32T corresponding to 2⁵, a sustaining period S₇ of a seventh subfield SF₇ is set to a time 64T corresponding to 2⁶, and a sustaining period S₈ of an eighth subfield SF₈ is set to a time 128T corresponding to 2⁷, respectively.

Accordingly, by appropriately selection of subfields to be displayed, a display with 256 gradations including a zero (0) gradation that corresponds to no display can be implemented.

In each of the initializing periods R₁, . . . , R₈, an initialization driving power of the eighth subfield SF₈ having the largest gradation weight is lower than that of each of the first through seventh subfields SF₁ through SF₇. Accordingly, the initialization operation in the eighth subfield SF₈ can be properly performed. This occurs because the seventh subfield S₇ immediately before the eighth subfield SF₈ has a long sustaining period SF₇ and thus induces a sufficient amount of wall charges around electrode lines at the start point of the eight subfield SF₈.

As described above, since the initialization operation is accurately performed during the eighth subfield SF₈ having the largest gradation weight, the addressing operation during the following addressing period A₈ can be more accurately performed. In other words, the accurate operation in the eighth subfield SF₈ having the largest gradation weight can enhance image reproducibility.

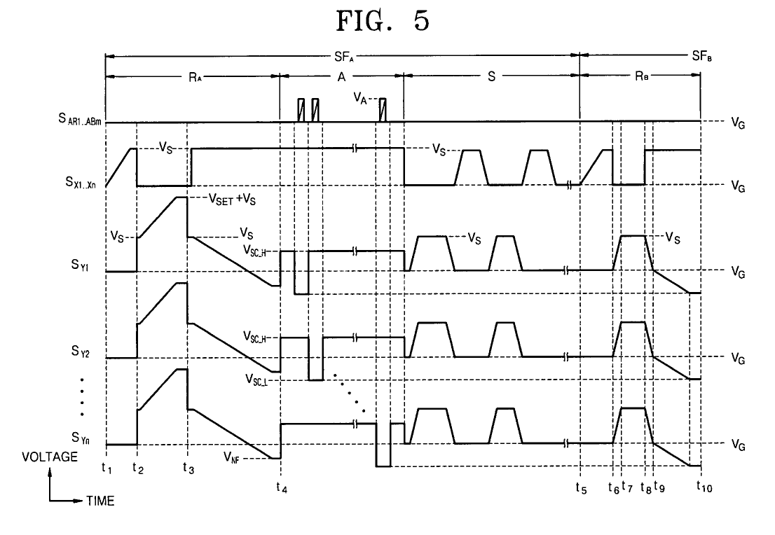

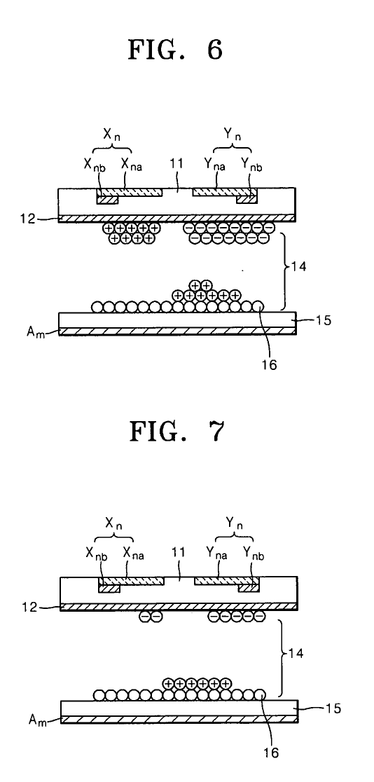

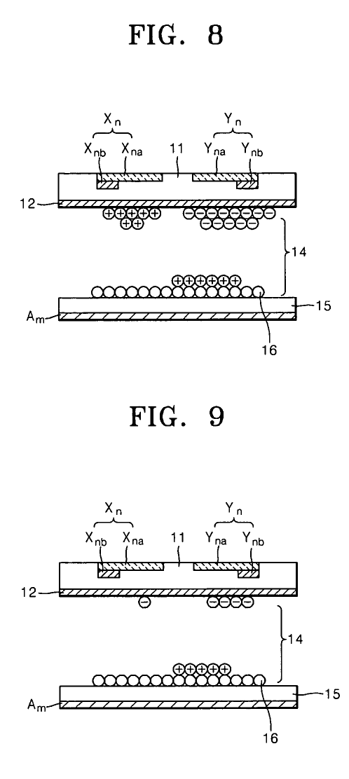

FIG. 5 illustrates driving signals transmitted to the electrode lines of the discharge display panel 1 of FIG. 1 in a subfield SF_{A} and another subfield SF_{B} illustrated in FIG. 4. Waveforms of driving signals in the subfield SF_{A} during an addressing period A and a sustaining period S are substantially identical to those of the subfield SF_{B}. In FIG. 6, reference numeral S_{AR1}, . . . A_{Bm} indicates a driving signal applied to each of the address electrode lines (A_{R1}, A_{G1}, . . . , A_{Gm}, A_{Bm} of FIG. 1), reference numeral S_{X1}, . . . Xₙ indicates a driving signal applied to each of the X electrode lines (X₁, . . . , Xₙ of FIG. 1), and reference numeral S_{Y1}, . . . . , S_{Yn} indicates a driving signal applied to each of the Y electrode lines (Y₁, . . . , Yₙ of FIG. 1). FIG. 6 is a cross-sectional view illustrating the distribution of wall charges of a display cell at a t₃ timing of FIG. 5. FIG. 7 is a cross-sectional view illustrating the distribution of wall charges of a display cell at a t₄ timing of FIG. 5. FIG. 8 is a cross-sectional view illustrating the distribution of wall charges of a display cell at a t₈ timing of FIG. 5. FIG. 9 is a cross-sectional view illustrating the distribution of wall charges of a display cell at too timing of FIG. 5. In FIGS. 6 through 9, components having the same reference numerals as those of FIG. 2 operate in substantially the same manner as the corresponding components of FIG. 2.

The driving signals transmitted to the electrode lines of the discharge display panel 1 of FIG. 1 in the subfield SFA illustrated in FIG. 4 will now be described with reference to FIGS. 5 through 7.

During a first period between a t1 timing and a t2 timing included during an initializing period R_{A} of the subfield SF_{A}, a voltage applied to the X electrode lines X₁, . . . , Xₙ as the first electrode lines is raised from a ground voltage V_{G} to a second voltage V_{S}. The ground voltage V_{G} is applied to the Y electrode lines Y₁, . . . , Yₙ and the address electrode lines A_{R1}, . . . , A_{Bm}. Accordingly, a weak discharge is generated between the Y electrode lines Y₁, . . . , Yₙ and the X electrode lines X₁, . . . , Xₙ and between the Y electrode lines Y₁, . . . , Yₙ and the address electrode lines A_{R1}, . . . , A_{Bm}. Consequently, wall charges with negative polarity are formed around the X electrode lines X₁, . . . , Xₙ.

During a second period, which is a first voltage-rising period, between the t₂ timing and the t₃ timing, a voltage applied to the Y electrode lines Y₁, . . . , Yₙ as the second display electrode lines is raised from the second voltage V_{S} to a first voltage V_{SET}+V_{S}, which is higher than the second voltage V_{S} by a fifth voltage V_{SET}. Here, the ground voltage V_{G} is applied to the X electrode lines X₁, . . . , Xₙ and the address electrode lines A_{R1}, . . . , A_{Bm}. Accordingly, a weak discharge is generated between the Y electrode lines Y₁, . . . , Yₙ and the X electrode lines X₁, . . . , Xₙ, while a weaker discharge is generated between the Y electrode lines Y₁, . . . , Yₙ and the address electrode lines A_{R1}, . . . , A_{Bm}. The reason why the discharge between the Y electrode lines Y₁, . . . , Yₙ and the X electrode lines X₁, . . . , Xₙ is stronger than the discharge between the Y electrode lines Y₁, . . . , Yₙ and the address electrode lines A_{R1}, . . . , A_{Bm} is that the wall charges with negative polarity are formed around the X electrode lines X₁, . . . , Xₙ. That is, many wall charges with negative polarity are formed around the Y electrode lines Y₁, . . . , Yₙ, while wall charges with positive polarity are formed around the X electrode lines X₁, . . . , Xₙ, and some wall charges with positive polarity are formed around the address electrode lines A_{R1}, . . . , A_{Bm} (see FIG. 6).

During a third period, which is a voltage falling period, between the t₃ timing and the t₄ timing, the voltage applied to the Y electrode lines Y₁, . . . , Yₙ falls from the second voltage V_{S} to a third voltage V_{NF} which is lower than the ground voltage V_{G} while the voltage applied to the X electrode lines X₁, . . . , Xₙ is maintained at the second voltage V_{S}. The ground voltage V_{G} is applied to the address electrode lines A_{R1}, . . . , A_{Bm}. Some of the wall charges with negative polarity formed around the Y electrode lines Y₁, . . . , Yₙ, move to and stay near the X electrode lines X₁, . . . , Xₙ due to a discharge between the X electrode lines X₁, . . . , Xₙ and the Y electrode lines Y₁, . . . , Yₙ (see FIG. 7). In addition, wall voltages of the X electrode lines X₁, . . . , Xₙ are lower than those of the address electrode lines A_{R1}, . . . , A_{Bm} and higher than those of the Y electrode lines Y₁, . . . , Yₙ. In the following addressing period A, an addressing voltage V_{A}-V_{SC}_{_{—}}_{L} for an opposed discharge between selected address electrode lines and the Y electrode lines Y₁, . . . , Yₙ may be lowered. Since the ground voltage V_{G} is applied to all the address electrode lines A_{R1}, . . . , A_{Bm}, the address electrode lines A_{R1}, . . . , A_{Bm} perform a discharge for the X electrode lines X₁, . . . , Xₙ and the Y electrode lines Y₁, . . . , Yₙ. Because of this discharge, wall charges with positive polarity formed around the address electrode lines A_{R1}, . . . , A_{Bm} are substantially eliminated (see FIG. 7).

In the following addressing period A, a display data signal is transmitted to the address electrode lines A_{R1}, . . . , A_{Bm}, and scan signals having a seventh voltage V_{SC}_{_{—}}_{L} (lower than the ground voltage V_{G}) are sequentially transmitted to the Y electrode lines Y₁, . . . , Yₙ which are biased by a sixth potential V_{SC}_{_{—}}_{H} which is lower than the second voltage V_{S}, so that smooth addressing can be performed.

As the display data signal is transmitted to each of the address electrode lines A_{R1}, . . . , A_{Bm}, an addressing voltage V_{A} with positive polarity is applied to selected display cells, and the ground potential V_{G} is applied to the remaining display cells. Accordingly, if the display data signal having the positive-polarity addressing voltage V_{A} is transmitted while scan pulses having the ground voltage V_{G} are applied, wall charges are formed by addressing discharge in the corresponding display cells and no wall charges are formed in the other display cells. Thus, to correctly and efficiently perform addressing discharge, the second voltage V_{S} is applied to the X electrode lines X₁, . . . , Xₙ.

In the following sustaining period S, discharge-sustain pulses of the second voltage V_{S} with positive polarity are alternately applied to the Y electrode lines Y₁, . . . , Yₙ and the X electrode lines X₁, . . . , Xₙ, so that discharge for discharge-sustain is generated in the display cells with the wall charges formed in the corresponding addressing period A.

Driving signals transmitted to the electrode lines of the discharge display panel 1 of FIG. 1 in the subfield SF_{B} illustrated in FIG. 5 will now be described with reference to FIGS. 5, 8, and 9.

During a first period between a t₅ timing and a t₆ timing during an initializing period R_{B} of the subfield SF_{B}, a voltage applied to the X electrode lines X₁, . . . , Xₙ is raised from the ground voltage V_{G} to the second voltage V_{S}. The ground voltage V_{G} is applied to the Y electrode lines Y₁, . . . , Yₙ and the address electrode lines A_{R1}, . . . , A_{Bm}. Accordingly, a weak discharge occurs between the X electrode lines X₁, . . . , Xₙ and the Y electrode lines Y₁, . . . , Yₙ and between the X electrode lines X₁, . . . , Xₙ and the address electrode lines A_{R1}, . . . , A_{Bm} in display cells in which the sustain-discharge occurred during the sustaining period S of the previous subfield. Consequently, wall charges with negative polarity are formed around the X electrode lines X₁, . . . , Xₙ.

During a second period, which is a second voltage rising period, between a t₆ timing and a t₇ timing, the voltage applied to the Y electrode lines Y₁, . . . , Yₙ is raised to the second voltage V_{S}. Here, the ground voltage V_{G} is applied to the X electrode lines X₁, . . . , Xₙ and the address electrode lines A_{R1}, . . . , A_{Bm}. Accordingly, wall charges with positive polarity are formed around the Y electrode lines Y₁, . . . , Yₙ, wall charges with positive polarity are formed around the X electrode lines X₁, . . . , Xₙ, and wall charges with positive polarity are formed around the address electrode lines A_{R1}, . . . , A_{Bm} in the display cells in which the sustain-discharge occurred during the sustaining period S of the previous subfield (see FIG. 8).

During the second period, which is the second voltage rising period, between the t₆ timing and the t₇ timing, when the subfield SF_{B} is the subfield having the largest gradation weight (the eighth subfield SF₈ in FIG. 4), the voltage applied to the Y electrode lines Y₁, . . . , Yₙ is raised to the second voltage Vs with a profile configured to result in driving power lower than in SF_{A}. Accordingly, the initializing operation of the eighth field SF₈ having the largest gradation weight can be performed properly since the seventh subfield S₇ immediately before the eighth subfield SF₈ has a long sustaining period S₇ and induces a sufficient amount of wall charges around the electrode lines at the start point (t₅ timing) of the eight subfield SF₈.

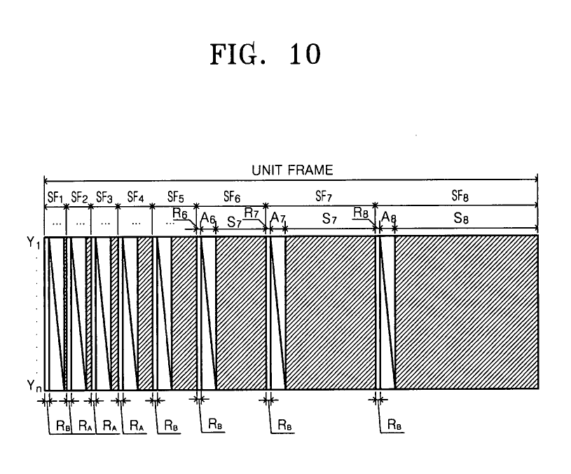

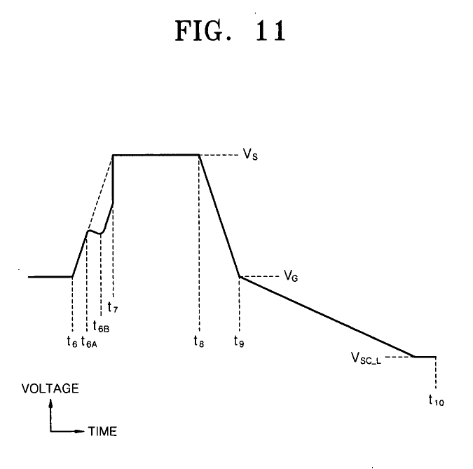

As described above, since the initialization operation can be accurately performed for the eighth subfield SF₈ having the largest gradation weight, the addressing operation during the following addressing period A₈ can be more accurately performed. In other words, the accurate operation during the eighth subfield SF₈ having the largest gradation weight can enhance image reproducibility, which will be described in more detail later with reference to FIGS. 10 and 11.

During a third period between a t₇ timing and a t₈ timing, the voltage applied to the Y electrode lines Y₁, . . . , Yₙ is maintained at the second voltage V_{S}, thereby facilitating proper stabilization.

During a fourth period, which is a voltage falling period, between a t₈ timing through a t₁₀ timing, the voltage applied to the Y electrode lines Y₁, . . . , Yₙ falls from the second voltage V_{S} to the seventh voltage V_{SC}_{_{—}}_{L} which is lower than the ground voltage V_{G} while the voltage applied to the X electrode lines X₁, . . . , Xₙ is maintained at the second voltage V_{S}. Here, the ground voltage V_{G} is applied to the address electrode lines A_{R1}, . . . , A_{Bm}. Accordingly, some of the wall charges with negative polarity, which are formed around the Y electrode lines Y₁, . . . , Yₙ, move to and stay around the X electrode lines X₁, . . . , Xₙ due to a discharge between the X electrode lines X₁, . . . , Xₙ and the Y electrode lines Y₁, . . . , Yₙ (see FIG. 9). In addition, the wall voltages of the X electrode lines X₁, . . . , Xₙ are lower than those of the address electrode lines A_{R1}, . . . , A_{Bm} and higher than those of the Y electrode lines Y₁, . . . , Yₙ. In the following addressing period A, an addressing voltage V_{A}-V_{G} for the opposed discharge between selected address electrode lines and the Y electrode lines Y₁, . . . , Yₙ may be lowered. Since the ground voltage V_{G} is applied to all the address electrode lines A_{R1}, . . . , A_{Bm}, the address electrode lines A_{R1}, . . . , A_{Bm} perform a discharge for the X electrode lines X₁, . . . , Xₙ and the Y electrode lines Y₁, . . . , Yₙ. Due to this discharge, wall charges with positive polarity formed around the address electrode lines A_{R1}, . . . , A_{Bm} are eliminated (see FIG. 9).

FIG. 10 is a timing diagram illustrating first and second initialization types R_{A} and R_{B} of FIG. 5 applied in each subfield of a unit frame according to an embodiment. Referring to FIGS. 5 and 10, the second initialization type R_{B} is used in initializing periods R₁ and R₅ through R₈ of subfields SF₁ and SF₅ through SF₈ whose previous subfields have relatively long sustaining periods S, respectively. The first initialization type R_{A} is used in initializing periods R₂ through R₄ of subfields SF₂ through SF₄ whose previous subfields have relatively short sustaining periods S, respectively. Since the initialization operation is properly and effectively performed, the contrast of the discharge display apparatus can be enhanced, power consumption can be reduced, and the life of the discharge display apparatus can be extended. When the initializing period R₈ of the eighth subfield SF₈ having the largest weight uses the second initialization type R_{B}, a signal transmitted to the Y electrode lines Y₁, . . . , Yₙ as the second display electrode lines illustrated in FIG. 1 is modified as illustrated in FIG. 11.

FIG. 11 is a waveform diagram illustrating a case where the initializing period R₈ of the eighth subfield SF₈ having the largest weight uses the second initialization type R_{B} according to an embodiment. Referring to FIG. 11, during the second period, which is the second voltage rising period, between the t₆ timing and the t₇ timing, the voltage applied to the Y electrode lines Y₁, . . . , Yₙ as the second display electrode lines is raised to the second voltage V_{S} with a profile configured to lower the driving power.

Specifically, there exists a period between a t_{6A} timing and a t_{6B} timing during which the driving power stops being supplied. In other words, in the second period, which is the second voltage rising period, between the t₆ timing and the t₇ timing, the voltage stops being applied to the Y electrode lines Y₁, . . . , Yₙ during the period between the t_{6A} timing and the t_{6B} timing.

Accordingly, the initializing operation in the eighth field SF₈ having the largest gradation weight can be performed properly since the seventh subfield S₇ immediately before the eighth subfield SF₈ has a long sustaining period S₇ and thus a sufficient amount of wall charges are formed around the electrode lines at the start point (t₅ timing) of the eight subfield SF₈. As described above, since the initialization operation can be accurately performed during the eighth subfield SF₈ having the largest gradation weight, the operation in the following addressing period A₈ can be more accurately performed. In other words, the accurate operation in the eighth subfield SF₈ having the largest gradation weight can enhance image reproducibility.

Waveforms in the third period between the t₇ timing and t₈ timing and the fourth period between the t₈ timing through the t₁₀ timing are substantially identical to those of the second initialization type R_{B} of FIG. 5, and therefore, a detailed description thereof will not be repeated.

As described above, in a method of driving a discharge display panel according to the present invention, a driving power for initialization in a subfield having a large gradation weight is the lower. Therefore, an initialization operation can be properly performed in the subfield having the largest gradation weight because a subfield immediately before the subfield having the largest gradation weight has a long sustaining period and thus a sufficient amount of wall charges are formed around electrode lines at a start point of the subfield having the largest gradation weight. In some embodiments, the power lowering profile is based at least in part on the duration of the subfield with the largest gradation weight.

Because the initialization operation is accurately performed in the subfield having the largest gradation weight, an operation in the following addressing period can be more accurately performed. In other words, the accurate operation in the subfield having the largest gradation weight can enhance image reproducibility.

While the present invention has been particularly shown and described with reference to embodiments thereof, it will be understood by those of ordinary skill in the art that various changes in form and details may be made therein without departing from the spirit and scope of the present invention.

What is claimed is:

1. A method of driving a discharge display panel, the method comprising:
dividing a unit frame into a plurality of subfields for time-division gradation display; and
dividing each of the subfields into an initialization period, an addressing period, and a sustaining period,
wherein a driving power for initialization in a subfield having a higher gradation weight is lower than a driving power for initialization in a subfield having a lower gradation weight.

2. The method of claim 1, wherein the lower driving power is supplied during the initializing period of a subfield having the largest gradation weight and the higher driving power is supplied in an initializing period of one or more of the other subfields.

3. The method of claim 2, wherein the driving power rises at a substantially constant rising rate and then falls at a substantially constant falling rate during the initializing period of the one or more other subfields, and the driving power rises with a power lowering profile and then falls at another substantially constant falling rate during the initializing period of the subfield having the larger gradation weight.

4. The method of claim 3, wherein the power lowering profile comprises a period of substantially zero driving power.

5. The method of claim 3, wherein the discharge display panel comprises:
a front substrate and a rear substrate disposed with a gap therebetween;
first display electrode lines and second electrode lines arranged alternately and in parallel to one another between the front and rear substrates;and
address electrode lines crossing the first and second electrode lines,
wherein a voltage applied to the second display electrode lines rises at the substantially constant rising rate and then falls at the substantially constant falling rate during the initializing period of the one or more other subfields, and a voltage applied to the second display electrode lines rises with a power lowering profile and then falls at the other substantially constant falling rate during the initializing period of the subfield having the larger gradation weight.

6. The method of claim 5, wherein the power lowering profile comprises a period of substantially zero driving power.

7. The method of claim 5, wherein
at least one of the one or more other subfields comprises:
a first voltage rising period during which the voltage applied to the second display electrode lines rises to a first voltage at the substantially constant rising rate; and
a falling period during which the voltage applied to the second display electrode lines falls at the substantially constant falling rate to a third voltage while the voltage applied to the first display electrode lines is maintained at the second voltage, the third voltage being lower than a second voltage and lower than the first voltage, wherein at least one of the other subfields comprises:
a second voltage rising period during which the voltage applied to the second display electrode lines rises at the substantially constant rising rate to the second voltage; and
a falling period during which the voltage applied to the second display electrode lines falls at the substantially constant falling rate to a fourth voltage while the voltage applied to the first display electrode lines is maintained as the second voltage, the fourth voltage being lower than the second voltage, and
the initializing period of the subfield having the larger gradation weight comprises:
a second voltage rising period during which the voltage applied to the second display electrode lines rises to the second voltage with a power lowering profile; and
a falling period during which the voltage applied to the second display electrode lines falls at the substantially constant falling rate from the fourth voltage while the voltage applied to the first display electrode lines is substantially maintained at the second voltage.

8. The method of claim 7, wherein the power lowering profile comprises a period of substantially zero driving power.

9. The method of claim 7, wherein, during the initializing period of each of the subfields, the voltage applied to the first display electrode lines rises to the second voltage at the substantially constant rising rate substantially immediately before the voltage applied to the second display electrode lines rises to the first voltage.

10. A time-division gradation method of driving a discharge display panel, the method comprising:
driving the display panel during a unit frame period, the unit frame period comprising a plurality of subfields, each subfield comprising an initialization period, an addressing period, and a sustaining period, and each of the plurality of subfields having a respective gradation weight;
driving the display panel during a first one of the subfields with a signal having a first driving power during an initialization period of the first subfield, the first subfield having a first gradation weight; and
driving the display panel during a second subfield with a signal having a second driving power during an initialization period of the second subfield, the second subfield having a second gradation weight,
wherein the first driving power is higher than the second driving power, and the first gradation weight is lower than the second gradation weight.

11. The method of claim 10, wherein the second subfield has the highest gradation weight of the plurality of gradation weights.

12. The method of claim 10, wherein the signal with the second driving power comprises a rising period with a power lowering profile.

13. The method of claim 10, wherein the power lowering profile is based at least in part on the duration of the second subfield.

14. The method of claim 12, wherein the driving power of the signal with the second driving power is substantially zero during a portion of the second subfield.

15. The method of claim 14, wherein the driving power of the signal with the second driving power is substantially zero during a portion of the second subfield when the voltage of the signal is rising.

16. The method of claim 10, wherein the signal with the first driving power and the signal with the second driving power each comprise a rising portion, and the first driving power being higher than the second driving power is at least in part a result of a difference between the rising portion of the signal with the second driving power and the rising portion of the signal with the first driving power.

17. The method of claim 16, wherein the voltage of the signal with the first driving power rises at a substantially constant rate during the rising period of the signal with the first driving power.

18. The method of claim 16, wherein the voltage of the signal with the second driving power rises with a power lowering profile during the rising period of the signal with the second driving power.

19. The method of claim 18, wherein the driving power of the signal with the second driving power is substantially zero during the rising period of the signal with the second driving power.

20. The method of claim 10, further comprising driving the display during at least one additional subfield with a signal having the first driving power during the initialization period of the additional subfield, the additional subfield having a gradation weight less than the first and second gradation weights.
